(19) United States
(12) Patent Application Publication
(10) Pub. No.: US 2025/0224495 A1
(43) Pub. Date: Jul. 10, 2025

(54) Rotating LIDAR

(71) Applicant: Innoviz Technologies Ltd., Rosh HaAyin (IL)

(72) Inventors: Nir Goren, Herut (IL); Nimrod Ari, Kochav-Yair (IL); Yonatan Korner, Modi'in-Maccabim-Re'ut (IL); Zachary Noll, Ramat Gan (IL)

(21) Appl. No.: 19/012,985

(22) Filed: Jan. 8, 2025

Related U.S. Application Data
(60) Provisional application No. 63/618,917, filed on Jan. 9, 2024.

(51) Int. Cl. G01S 7/484; G01S 7/481; G01S 7/4863; G01S 7/4865; G01S 17/89; G01S 17/931

(52) U.S. Cl. CPC G01S 7/484; G01S 7/4811; G01S 7/4815; G01S 7/4817; G01S 7/4863; G01S 7/4865; G01S 17/89; G01S 17/931

(57) ABSTRACT

A rotatable LIDAR system includes a rotor configured to rotate about a central rotational axis and multiple optical components mounted to the rotor such that the optical components are configured to rotate about the central rotational axis. The optical components include a first light source configured to emit first light towards a first portion of a field of view (FOV) with a first range, a first light detector configured to receive reflections of the first light from first objects in the first portion of the FOV, at least one second light source configured to emit second light towards a second portion of the FOV with a second range shorter than the first range, and a second light detector configured to receive reflections of the second light from second objects in the second portion of the FOV. Other embodiments are also described.

### CROSS-REFERENCE TO RELATED APPLICATIONS

The present application claims the benefit of U.S. Provisional Application 63/618,917, filed Jan. 9, 2024, entitled “Rotating lidar systems and methods,” whose disclosure is incorporated herein by reference.

### FIELD OF EMBODIMENTS OF THE INVENTION

The present disclosure relates generally to technology for scanning a surrounding environment and, for example, to systems and methods that use LIDAR technology to detect objects in the surrounding environment.

### BACKGROUND

With the advent of driver assist systems and autonomous vehicles, automobiles need to be equipped with systems capable of reliably sensing and interpreting their surroundings, including identifying obstacles, hazards, objects, and other physical parameters that might impact navigation of the vehicle. To this end, a number of differing technologies have been suggested including radar, LIDAR, camera-based systems, operating alone or in a redundant manner.

One consideration with driver assistance systems and autonomous vehicles is the ability of the system to determine surroundings across different conditions. A light detection and ranging system (LIDAR a/k/a LADAR) is an example of technology that operates by illuminating objects with light and measuring the reflected pulses with a sensor. Based on measured times of flight at different spatial locations, in a field of view (FOV), such as FOV pixels, a point cloud of range data may be generated where each FOV pixel is associated with a particular range measurement value corresponding to a distance between the LIDAR system and objects or portions of objects in the LIDAR FOV. A laser is one example of a light source that can be used in a LIDAR system. An electro-optical system such as a LIDAR system may include a light deflector for projecting light emitted by a light source into the environment of the electro-optical system. The light deflector may be controlled to pivot around at least one axis for projecting the light into a desired location in the field of view of the electro-optical system.

Different design considerations may come into plan for a rotatable LIDAR system that is configured to rotate 360 degrees. In particular, 360 degree LIDAR systems designed for trucks may have certain portions of the field of view that are critical to measure in contrast with smaller vehicles and certain considerations may relate to scanning this field of view. These considerations may relate to certain components and how the components are configured relative to one another, the design of the scanner in the LIDAR system, the size and configuration of optical paths in the LIDAR system, the size of components and the size of the overall LIDAR system, and more. The systems and methods disclosed herein are directed towards addressing these considerations to achieve a rotatable LIDAR system that provides high standards of performance while having a sufficiently small form factor.

### SUMMARY

In an embodiment, a rotatable LIDAR system is disclosed. The LIDAR system may include a rotor having a central rotational axis 940 (shown in FIG. 7), and a plurality of optical component mounting locations. The components mounted at the plurality of optical component mounting locations may be configured to rotate around the central rotational axis. The LIDAR system may include a first light source and at least one other second light source, each mounted at one of the plurality of optical component mounting locations. The first light source may be configured to emit light towards a first portion of the field of view with a first range and the second light source may be configured to emit light towards a second portion of the field of view (FOV) with a second range. The first range may be longer than the second range. The LIDAR system may include a first light detector and a second light detector, each mounted at one of the plurality of optical component mounting locations and configured to receive, while the rotor rotates, reflections of light from objects in the field of view.

There is provided, in accordance with some embodiments of the present invention, a rotatable LIDAR system including a rotor configured to rotate about a central rotational axis and multiple optical components mounted to the rotor such that the optical components are configured to rotate about the central rotational axis. The optical components include a first light source configured to emit first light towards a first portion of a field of view (FOV) with a first range, a first light detector configured to receive reflections of the first light from first objects in the first portion of the FOV, at least one second light source configured to emit second light towards a second portion of the FOV with a second range shorter than the first range, and a second light detector configured to receive reflections of the second light from second objects in the second portion of the FOV.

In some embodiments, the rotor includes at least two stages, and the optical components are mounted to the stages.

In some embodiments, the at least two stages are spaced apart along the central rotational axis.

In some embodiments, the first light source is mounted to a first one of the at least two stages, and the second light source is mounted to a second one of the at least two stages.

In some embodiments, the rotatable LIDAR system further includes a rounded window enclosing the second one of the at least two stages.

In some embodiments, the at least two stages are removably attached to one another.

In some embodiments, the first portion of the FOV is offset from the second portion of the FOV.

In some embodiments, the first portion of the FOV and the second portion of the FOV do not overlap.

In some embodiments, a yaw angle is defined by rotation about the central rotational axis, and an instantaneous FOV illuminated by the first light source and an instantaneous FOV illuminated by the second light source have different yaw angles at any time.

In some embodiments, an instantaneous FOV illuminated by the first light source and an instantaneous FOV illuminated by the second light source do not overlap at any time.

In some embodiments, a pitch angle is defined by a rotation about an axis perpendicular to the central rotational axis, and an instantaneous FOV illuminated by the first light source and an instantaneous FOV illuminated by the second light source have different pitch angles.

In some embodiments, a pitch range of the second portion of the FOV is at least double a pitch range of the first portion of the FOV.

In some embodiments, the rotor is configured to mount to a vehicle such that, when the vehicle is on a road, the second portion of the FOV includes the road.

In some embodiments, the first light source includes an edge emitter laser.

In some embodiments, the second light source includes a VCSEL array.

In some embodiments, a wavelength of the first light differs from a wavelength of the second light.

In some embodiments, a resolution of FOV measurement is lower for the second portion of the FOV than for the first portion of the FOV.

In some embodiments, the first range is at least double the second range.

In some embodiments, the rotatable LIDAR system further includes a processor configured to control the first light source and second light source independently from one another.

In some embodiments, the rotatable LIDAR system further includes a processor configured to:

receive signals from the first light detector and second light detector indicative of the reflections of the first light and the reflections of the second light, and

based on the signals, generate a combined point cloud including the first objects and the second objects.

In some embodiments, the optical components further include a scanning unit configured to deflect the first light towards the first portion of the FOV.

The present invention will be more fully understood from the following detailed description of embodiments thereof, taken together with the drawings, in which:

### BRIEF DESCRIPTION OF THE DRAWINGS

FIG. 1 is a diagram illustrating an exemplary LIDAR system, consistent with some embodiments of the present disclosure;

FIG. 2 is a diagram illustrating different configurations of projecting units, consistent with some embodiments of the present disclosure;

FIG. 3 is a diagram illustrating an example of a monolithic laser array, consistent with some embodiments of the present disclosure;

FIG. 4 is a diagram illustrating an exemplary configuration of a sensing unit (or monolithic detector), consistent with some embodiments of the present disclosure;

FIG. 5 is a diagram schematically illustrating portions of the field of view scanned by an exemplary conventional LIDAR system mounted to a vehicle, consistent with some embodiments of the present disclosure;

FIG. 6A is a diagram illustrating an exemplary LIDAR system mounted to a vehicle, consistent with some embodiments of the present disclosure;

FIG. 6B is a diagram illustrating top view of the field of view scanned by an exemplary LIDAR system mounted to a vehicle, consistent with some embodiments of the present disclosure;

FIG. 6C is a diagram illustrating a side view of the field of view scanned by an exemplary LIDAR system mounted to a vehicle, consistent with some embodiments of the present disclosure;

FIG. 7 is a diagram illustrating an exemplary multi-stage LIDAR system, consistent with some embodiments of the present disclosure;

FIG. 8 is a diagram illustrating a schematic of the exemplary multi-stage LIDAR system, consistent with some embodiments of the present disclosure;

FIG. 9A is a diagram illustrating a side view of the exemplary multi-stage LIDAR system, consistent with some embodiments of the present disclosure;

FIG. 9B is a diagram illustrating a top view of the exemplary multi-stage LIDAR system, consistent with some embodiments of the present disclosure; and

FIG. 9C is a schematic illustration of a LIDAR system illuminating a field of view, in accordance with some embodiments of the present disclosure.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Moreover, various terms used in the specification and claims may be defined or summarized differently when discussed in connection with differing disclosed embodiments.

It is to be understood that the definitions, summaries, and explanations of terminology in each instance apply to all instances, even when not repeated, unless the transitive definition, explanation or summary would result in inoperability of an embodiment.

Throughout, this disclosure mentions “disclosed embodiments,” which refer to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic.

This disclosure employs open-ended permissive language, indicating for example, that some embodiments “may” employ, involve, or include specific features. The use of the term “may” and other open-ended terminology is intended to indicate that although not every embodiment may employ the specific disclosed feature, at least one embodiment employs the specific disclosed feature. Disclosed embodiments may involve an optical system. As used herein, the term “optical system” broadly includes any system that is used for the generation, detection and/or manipulation of light. By way of example only, an optical system may include one or more optical components for generating, detecting and/or manipulating light. For example, light sources, lenses, mirrors, prisms, beam splitters, collimators, polarizing optics, optical modulators, optical switches, optical amplifiers, optical detectors, optical sensors, fiber optics, semiconductor optic components, while each not necessarily required, may each be part of an optical system. In addition to the one or more optical components, an optical system may also include other non-optical components such as electrical components, mechanical components, chemical reaction components, and semiconductor components. The non-optical components may cooperate with optical components of the optical system. For example, the optical system may include at least one processor for analyzing detected light.

Consistent with the present disclosure, the optical system may be a LIDAR system. As used herein, the term “LIDAR system” broadly includes any system which can determine values of parameters indicative of a distance between a pair of tangible objects based on reflected light. In one embodiment, the LIDAR system may determine a distance between a pair of tangible objects based on reflections of light emitted by the LIDAR system. As used herein, the term “determine distances” broadly includes generating outputs which are indicative of distances between pairs of tangible objects. The determined distance may represent the physical dimension between a pair of tangible objects. By way of example only, the determined distance may include a line of flight distance between the LIDAR system and another tangible object in a field of view of the LIDAR system. In another embodiment, the LIDAR system may determine the relative velocity between a pair of tangible objects based on reflections of light emitted by the LIDAR system. Examples of outputs indicative of the distance between a pair of tangible objects include: a number of standard length units between the tangible objects (e.g., number of meters, number of inches, number of kilometers, number of millimeters), a number of arbitrary length units (e.g., number of LIDAR system lengths), a ratio between the distance to another length (e.g., a ratio to a length of an object detected in a field of view of the LIDAR system), an amount of time (e.g., given as standard unit, arbitrary units or ratio, for example, the time it takes light to travel between the tangible objects), one or more locations (e.g., specified using an agreed coordinate system, specified in relation to a known location), and more.

The LIDAR system may determine the distance between a pair of tangible objects (e.g., the LIDAR system and one or more objects in the LIDAR FOV) based on reflected light. In one embodiment, the LIDAR system may process detection results of a sensor which creates temporal information indicative of a period of time between the emission of a light signal and the time of its detection by the sensor. The period of time is occasionally referred to as “time of flight” of the light signal. In one example, the light signal may be a short pulse, whose rise and/or fall time may be detected in reception. Using known information about the speed of light in the relevant medium (usually air), the information regarding the time of flight of the light signal can be processed to provide the distance the light signal traveled between emission and detection. In another embodiment, the LIDAR system may determine the distance based on frequency phase-shift (or multiple frequency phase-shift). Specifically, the LIDAR system may process information indicative of one or more modulation phase shifts (e.g., by solving some simultaneous equations to give a final measure) of the light signal. For example, the emitted optical signal may be modulated with one or more constant frequencies. The at least one phase shift of the modulation between the emitted signal and the detected reflection may be indicative of the distance the light traveled between emission and detection. The modulation may be applied to a continuous wave light signal, to a quasi-continuous wave light signal, or to another type of emitted light signal. It is noted that additional information may be used by the LIDAR system for determining the distance, e.g., location information (e.g., relative positions) between the projection location, the detection location of the signal (especially if distanced from one another), and more.

In some embodiments, the LIDAR system may be used for detecting a plurality of objects in an environment of the LIDAR system. The term “detecting an object in an environment of the LIDAR system” broadly includes generating information which is indicative of an object that reflected light toward a detector associated with the LIDAR system. If more than one object is detected by the LIDAR system, the generated information pertaining to different objects may be interconnected, for example a car is driving on a road, a bird is sitting on the tree, a man touches a bicycle, a van moves towards a building. The dimensions of the environment in which the LIDAR system detects objects may vary with respect to implementation. For example, the LIDAR system may be used for detecting a plurality of objects in an environment of a vehicle on which the LIDAR system is installed, up to a horizontal distance of 100 m (or 200 m, 300 m, etc.), and up to a vertical distance of 10 m (or 25m, 50m, etc.). In another example, the LIDAR system may be used for detecting a plurality of objects in an environment of a vehicle or within a predefined horizontal range (e.g., 25°,50°, 100°, 180°, etc.), and up to a predefined vertical elevation (e.g., ±10°, ±20°, +40°-20°, ±90° or 0°-90°.

As used herein, the term “detecting an object” may broadly refer to determining an existence of the object (e.g., an object may exist in a certain direction with respect to the LIDAR system and/or to another reference location, or an object may exist in a certain spatial volume). Additionally or alternatively, the term “detecting an object” may refer to determining a distance between the object and another location (e.g., a location of the LIDAR system, a location on earth, or a location of another object). Additionally or alternatively, the term “detecting an object” may refer to identifying the object (e.g., classifying a type of object such as car, plant, tree, road; recognizing a specific object (e.g., the Washington Monument); determining a license plate number; determining a composition of an object (e.g., solid, liquid, transparent, semitransparent); determining a kinematic parameter of an object (e.g., whether it is moving, its velocity, its movement direction, expansion of the object). Additionally or alternatively, the term “detecting an object” may refer to generating a point cloud map in which every point of one or more points of the point cloud map correspond to a location in the object or a location on a face thereof. In one embodiment, the data resolution associated with the point cloud map representation of the field of view may be associated with 0.1°x0.1° or 0.3°x0.3° of the field of view.

Consistent with the present disclosure, the term “object” broadly includes a finite composition of matter that may reflect light from at least a portion thereof. For example, an object may be at least partially solid (e.g., cars, trees); at least partially liquid (e.g., puddles on the road, rain); at least partly gascous (e.g., fumes, clouds); made from a multitude of distinct particles (e.g., sand storm, fog, spray); and may be of one or more scales of magnitude, such as ˜1 millimeter (mm), ˜5 mm, ˜10 mm, ˜50 mm, ˜100 mm, ˜500 mm, ˜1 meter (m), ˜5 m, ˜10 m, ˜50 m, ˜100 m, and so on. Smaller or larger objects, as well as any size in between those examples, may also be detected. It is noted that for various reasons, the LIDAR system may detect only part of the object. For example, in some cases, light may be reflected from only some sides of the object (e.g., only the side opposing the LIDAR system will be detected); in other cases, light may be projected on only part of the object (e.g., laser beam projected onto a road or a building); in other cases, the object may be partly blocked by another object between the LIDAR system and the detected object; in other cases, the LIDAR's sensor may only detects light reflected from a portion of the object, e.g., because ambient light or other interferences interfere with detection of some portions of the object.

Consistent with the present disclosure, a LIDAR system may be configured to detect objects by scanning the environment of LIDAR system. The term “scanning the environment of LIDAR system” broadly includes illuminating the field of view or a portion of the field of view of the LIDAR system. In one example, scanning the environment of LIDAR system may be achieved by moving or pivoting a light deflector to deflect light in differing directions toward different parts of the field of view. In another example, scanning the environment of LIDAR system may be achieved by changing a positioning (i.e., location and/or orientation) of a sensor with respect to the field of view. In another example, scanning the environment of LIDAR system may be achieved by changing a positioning (i.e., location and/or orientation) of a light source with respect to the field of view. In yet another example, scanning the environment of LIDAR system may be achieved by changing the positions of at least one light source and of at least one sensor to move rigidly with respect to the field of view (i.e., the relative distance and orientation of the at least one sensor and of the at least one light source remains).

As used herein the term “field of view of the LIDAR system” may broadly include an extent of the observable environment of LIDAR system in which objects may be detected. It is noted that the field of view (FOV) of the LIDAR system may be affected by various conditions such as but not limited to: an orientation of the LIDAR system (e.g., is the direction of an optical axis of the LIDAR system); a position of the LIDAR system with respect to the environment (e.g., distance above ground and adjacent topography and obstacles); operational parameters of the LIDAR system (e.g., emission power, computational settings, defined angles of operation), etc. The field of view of LIDAR system may be defined, for example, by a solid angle (e.g., defined using ϕ, θ angles, in which ϕ and θ are angles defined in perpendicular planes, e.g., with respect to symmetry axes of the LIDAR system and/or its FOV). In one example, the field of view may also be defined within a certain range (e.g., up to 200 m).

Similarly, the term “instantaneous field of view” may broadly include an extent of the observable environment in which objects may be detected by the LIDAR system at any given moment. For example, for a scanning LIDAR system, the instantaneous field of view is narrower than the entire FOV of the LIDAR system, and it can be moved within the FOV of the LIDAR system in order to enable detection in other parts of the FOV of the LIDAR system. The movement of the instantaneous field of view within the FOV of the LIDAR system may be achieved by moving a light deflector of the LIDAR system (or external to the LIDAR system), so as to deflect beams of light to and/or from the LIDAR system in differing directions. In one embodiment, LIDAR system may be configured to scan a scene in the environment in which the LIDAR system is operating. As used herein the term “scene” may broadly include some or all of the objects within the field of view of the LIDAR system, in their relative positions and in their current states, within an operational duration of the LIDAR system. For example, the scene may include ground elements (e.g., earth, roads, grass, sidewalks, road surface marking), sky, manufactured objects (e.g., vehicles, buildings, signs), vegetation, people, animals, light projecting elements (e.g., flashlights, sun, other LIDAR systems), and so on.

Disclosed embodiments may involve obtaining information for use in generating reconstructed three-dimensional models. Examples of types of reconstructed three-dimensional models which may be used include point cloud models, and Polygon Mesh (e.g., a triangle mesh). The terms “point cloud” and “point cloud model” are widely known in the art, and should be construed to include a set of data points located spatially in some coordinate system (i.e., having an identifiable location in a space described by a respective coordinate system). The term “point cloud point” refer to a point in space (which may be dimensionless, or a miniature cellular space, e.g., 1 cm³), and whose location may be described by the point cloud model using a set of coordinates (e.g., (X, Y, Z), (r,ϕ,θ)). By way of example only, the point cloud model may store additional information for some or all of its points (e.g., color information for points generated from camera images). Likewise, any other type of reconstructed three-dimensional model may store additional information for some or all of its objects. Similarly, the terms “polygon mesh” and “triangle mesh” are widely known in the art, and are to be construed to include, among other things, a set of vertices, edges and faces that define the shape of one or more 3D objects (such as a polyhedral object). The faces may include one or more of the following: triangles (triangle mesh), quadrilaterals, or other simple convex polygons, since this may simplify rendering. The faces may also include more general concave polygons, or polygons with holes. Polygon meshes may be represented using differing techniques, such as: Vertex-vertex meshes, Face-vertex meshes, Winged-edge meshes and Render dynamic meshes. Different portions of the polygon mesh (e.g., vertex, face, edge) are located spatially in some coordinate system (i.e., having an identifiable location in a space described by the respective coordinate system), either directly and/or relative to one another. The generation of the reconstructed three-dimensional model may be implemented using any standard, dedicated and/or novel photogrammetry technique, many of which are known in the art. It is noted that other types of models of the environment may be generated by the LIDAR system.

Consistent with disclosed embodiments, the LIDAR system may include at least one projecting unit with a light source configured to project light. As used herein the term “light source” broadly refers to any device configured to emit light. In one embodiment, the light source may be a laser such as a solid-state laser, laser diode, a high-power laser, or an alternative light source such as, a light emitting diode (LED)-based light source. In addition, any light source illustrated throughout the figures, may emit light in differing formats, such as light pulses, continuous wave (CW), quasi-CW, and so on. For example, one type of light source that may be used is a vertical-cavity surface-emitting laser (VCSEL). Another type of light source that may be used is an external cavity diode laser (ECDL) or an edge-emitting laser. In some examples, the light source may include an array of lasers. In another example, the light source may include a single, monolithic laser array including a plurality of laser emitters. In some examples, the light source may include a laser diode configured to emit light at a wavelength between about 650 nm and 1150 nm. Alternatively, the light source may include a laser diode configured to emit light at a wavelength between about 800 nm and about 1000 nm, between about 850 nm and about 950 nm, or between about 1300 nm and about 1600 nm. Unless indicated otherwise, the term “about” with regards to a numeric value is defined as a variance of up to 5% with respect to the stated value.

Consistent with disclosed embodiments, the LIDAR system may include at least one scanning unit with at least one light deflector configured to deflect light from the light source in order to scan the field of view. The term “light deflector” broadly includes any mechanism or module which is configured to make light deviate from its original path; for example, a mirror, a prism, controllable lens, a mechanical mirror, mechanical scanning polygons, active diffraction (e.g., controllable LCD), Risley prisms, non-mechanical-electro-optical beam steering (such as made by Vscent), polarization grating (such as offered by Boulder Non-Linear Systems), optical phased array (OPA), and more. In one embodiment, a light deflector may include a plurality of optical components, such as at least one reflecting element (e.g., a mirror), at least one refracting element (e.g., a prism, a lens), and so on. In one example, the light deflector may be movable, to cause light deviate to differing degrees (e.g., discrete degrees, or over a continuous span of degrees). The light deflector may optionally be controllable in different ways (e.g., deflect to a degree α, change deflection angle by Δα, move a component of the light deflector by M millimeters, change speed in which the deflection angle changes). In addition, the light deflector may optionally be operable to change an angle of deflection within a single plane (e.g., θ coordinate). The light deflector may optionally be operable to change an angle of deflection within two non-parallel planes (e.g., θ and ϕ coordinates). Alternatively or additionally, the light deflector may optionally be operable to change an angle of deflection between predetermined settings (e.g., along a predefined scanning route) or otherwise. With respect the use of light deflectors in LIDAR systems, it is noted that a light deflector may be used in the outbound direction (also referred to as transmission direction, or TX) to deflect light from the light source to at least a part of the field of view. However, a light deflector may also be used in the inbound direction (also referred to as reception direction, or RX) to deflect light from at least a part of the field of view to one or more light sensors.

Disclosed embodiments may involve pivoting the light deflector in order to scan the field of view. As used herein the term “pivoting” broadly includes rotating of an object (especially a solid object) about one or more axis of rotation, while substantially maintaining a center of rotation fixed. In one embodiment, the pivoting of the light deflector may include rotation of the light deflector about a fixed axis (e.g., a shaft), but this is not necessarily so. In some cases, the fixed axis may be a substantially vertically oriented scanning axis, and pivoting of the deflector includes rotation of the deflector about the vertical scanning axis to project laser light to the LIDAR FOV, e.g., along one or more horizontally oriented scan lines. In some cases, the light deflector may be spun or rotated a full 360 degrees such that the horizontal scan lines extend over and establish a full 360-degree LIDAR FOV.

Disclosed embodiments may involve receiving reflections associated with a portion of the field of view corresponding to a single instantaneous position of the light deflector. As used herein, the term “instantaneous position of the light deflector” (also referred to as “state of the light deflector”) broadly refers to the location or position in space where at least one controlled component of the light deflector is situated at an instantaneous point in time, or over a short span of time. In one embodiment, the instantaneous position of light deflector may be gauged with respect to a frame of reference. The frame of reference may pertain to at least one fixed point in the LIDAR system. Or, for example, the frame of reference may pertain to at least one fixed point in the scene. In some embodiments, the instantaneous position of the light deflector may include some movement of one or more components of the light deflector (e.g., mirror, prism), usually to a limited degree with respect to the maximal degree of change during a scanning of the field of view. For example, a scanning of the entire the field of view of the LIDAR system may include changing deflection of light over a span of 30°, and the instantaneous position of the at least one light deflector may include angular shifts of the light deflector within 0.05°. In other embodiments, the term “instantaneous position of the light deflector” may refer to the positions of the light deflector during acquisition of light which is processed to provide data for a single point of a point cloud (or another type of 3D model) generated by the LIDAR system. In some embodiments, an instantaneous position of the light deflector may correspond with a fixed position or orientation in which the deflector pauses for a short time during illumination of a particular sub-region of the LIDAR field of view. In other cases, an instantaneous position of the light deflector may correspond with a certain position/orientation along a scanned range of positions/orientations of the light deflector that the light deflector passes through as part of a continuous or semi-continuous scan of the LIDAR field of view. In some embodiments, the light deflector may be moved such that during a scanning cycle of the LIDAR FOV the light deflector is located at a plurality of different instantaneous positions. In other words, during the period of time in which a scanning cycle occurs, the deflector may be moved through a series of different instantaneous positions/orientations, and the deflector may reach each different instantaneous position/orientation at a different time during the scanning cycle.

Consistent with disclosed embodiments, the LIDAR system may include at least one sensing unit with at least one sensor configured to detect reflections from objects in the field of view. The term “sensor” broadly includes any device, element, or system capable of measuring properties (e.g., power, frequency, phase, pulse timing, pulse duration) of electromagnetic waves and to generate an output relating to the measured properties. In some embodiments, the at least one sensor may include a plurality of detectors constructed from a plurality of detecting elements. The at least one sensor may include light sensors of one or more types. It is noted that the at least one sensor may include multiple sensors of the same type which may differ in other characteristics (e.g., sensitivity, size). Other types of sensors may also be used. Combinations of several types of sensors can be used for different reasons, such as improving detection over a span of ranges (especially in close range); improving the dynamic range of the sensor; improving the temporal response of the sensor; and improving detection in varying environmental conditions (e.g., atmospheric temperature, rain, etc.).In one embodiment, the at least one sensor includes a SiPM (Silicon photomultipliers) which is a solid-state single-photon-sensitive device built from an array of avalanche photodiode (APD), single photon avalanche diode (SPAD), serving as detection elements on a common silicon substrate. In one example, a typical distance between SPADs may be between about 10 μm and about 50 μm, wherein each SPAD may have a recovery time of between about 20 ns and about 100 ns. Similar photomultipliers from other, non-silicon materials may also be used. Although a SiPM device works in digital/switching mode, the SiPM is an analog device because all the microcells may be read in parallel, making it possible to generate signals within a dynamic range from a single photon to hundreds and thousands of photons detected by the different SPADs. It is noted that outputs from different types of sensors (e.g., SPAD, APD, SiPM, PIN diode, Photodetector) may be combined together to a single output which may be processed by a processor of the LIDAR system.

Consistent with disclosed embodiments, the LIDAR system may include or communicate with at least one processor configured to execute differing functions. The at least one processor may constitute any physical device or group of devices having electric circuitry that performs a logic operation on an input or inputs. For example, the at least one processor may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by at least one processor may, for example, be pre-loaded into a memory integrated with or embedded into the controller or may be stored in a separate memory. The memory may include a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the memory is configured to store information representative data about objects in the environment of the LIDAR system. In some embodiments, the at least one processor may include more than one processor. Each processor may have a similar construction or the processors may be of differing constructions that are electrically connected or disconnected from each other. For example, the processors may be separate circuits or integrated in a single circuit. When more than one processor is used, the processors may be configured to operate independently or collaboratively, and may be co-located or located remotely from each other. The processors may be coupled electrically, magnetically, optically, acoustically, mechanically or by other means that permit them to interact.

### System Overview

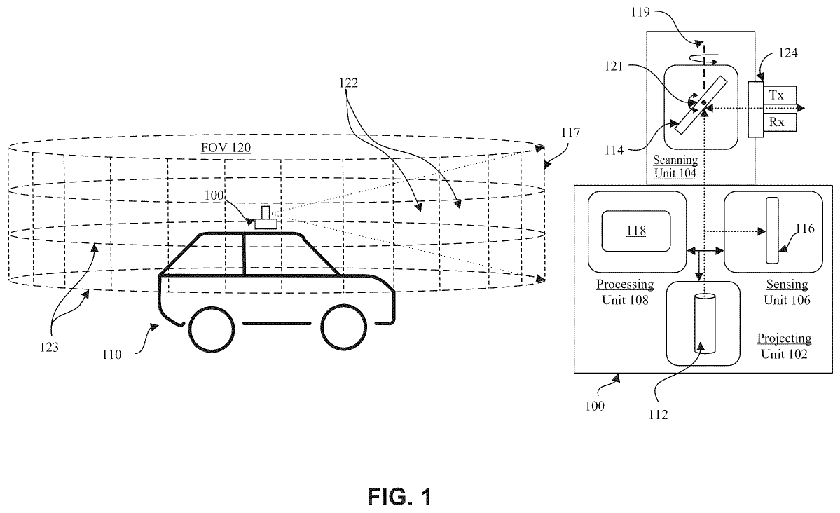

FIG. 1 illustrates a LIDAR system 100 including a projecting unit 102, a scanning unit 104, a sensing unit 106, and a processing unit 108. LIDAR system 100 may be mountable on a vehicle 110. Consistent with embodiments of the present disclosure, projecting unit 102 may include at least one light source 112, scanning unit 104 may include at least one light deflector 114, sensing unit 106 may include at least one sensor 116, and processing unit 108 may include at least one processor 118. Consistent with embodiments of the present disclosure, projecting unit 102 may include at least a first light source and a second light source.

In one embodiment, processor 118 may be configured (programmed) to coordinate operation of light source 112 with the movement of deflector 114 in order to scan a field of view 120. During a scanning cycle, each instantaneous position of at least one light deflector 114 may be associated with a particular portion 122 of field of view (FOV) 120. In addition, LIDAR system 100 may include at least one optional optical window 124 for directing light projected towards field of view 120 and/or receiving light reflected from objects in field of view 120. Optional optical window 124 may serve different purposes, such as collimation of the projected light and focusing of the reflected light. In one embodiment, optional optical window 124 may be an opening, a flat window, a curved window, a lens, or any other type of optical window.

Consistent with the present disclosure, LIDAR system 100 may be used in autonomous or semi-autonomous road-vehicles (for example, cars, buses, vans, trucks, and any other terrestrial vehicle). Autonomous road-vehicles with LIDAR system 100 may scan their environment and drive to a destination vehicle without human input. Similarly, LIDAR system 100 may also be used in autonomous/semi-autonomous aerial-vehicles (for example, UAV, drones, quadcopters, and any other airborne vehicle or device); or in an autonomous or semi-autonomous water vessel (e.g., boat, ship, submarine, or any other watercraft). Autonomous aerial-vehicles and watercraft with LIDAR system 100 may scan their environment and navigate to a destination autonomously or using a remote human operator. According to one embodiment, vehicle 110 (either a road-vehicle, aerial-vehicle, or watercraft) may use LIDAR system 100 to aid in detecting and scanning the environment in which vehicle 110 is operating.

It should be noted that LIDAR system 100 or any of its components may be used together with any of the example embodiments and methods disclosed herein. Further, while some aspects of LIDAR system 100 are described relative to an exemplary vehicle-based LIDAR platform, LIDAR system 100, any of its components, or any of the processes described herein may be applicable to LIDAR systems of other platform types.

### The Projecting Unit

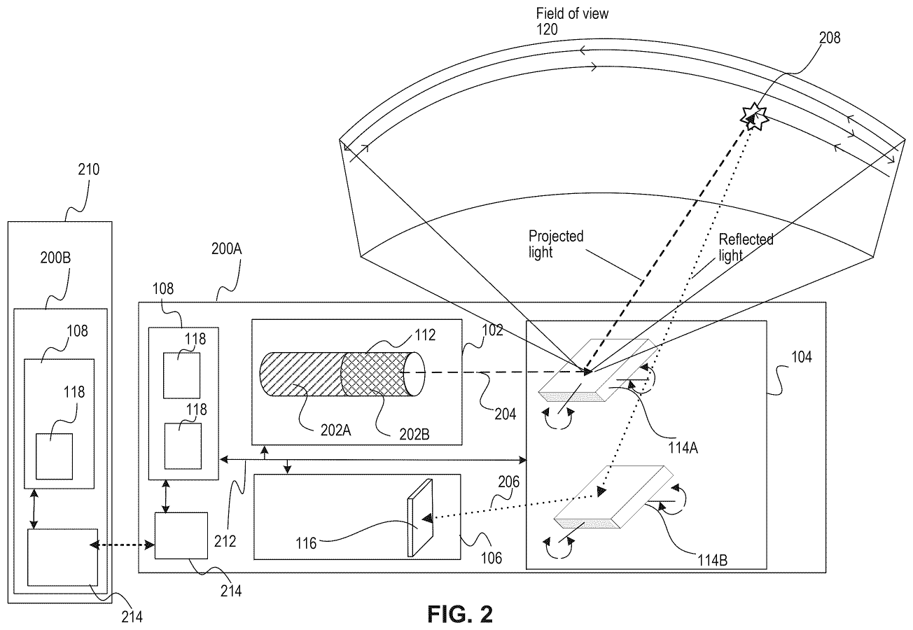

FIG. 2 illustrates an example of a bi-static configuration of LIDAR system 100 in which projecting unit 102 includes a single light source 112. The term “bi-static configuration” broadly refers to LIDAR systems configurations in which the projected light exiting the LIDAR system and the reflected light entering the LIDAR system pass through substantially different optical paths. In some embodiments, a bi-static configuration of LIDAR system 100 may include a separation of the optical paths by using completely different optical components, by using parallel but not fully separated optical components, or by using the same optical components for only part of the of the optical paths (optical components may include, for example, windows, lenses, mirrors, beam splitters, etc.). In the example depicted in FIG. 2, the bi-static configuration includes a configuration where the outbound light and the inbound light pass through a single optical window 124 but scanning unit 104 includes two light deflectors, a first light deflector 114A for outbound light and a second light deflector 114B for inbound light (the inbound light in LIDAR system includes emitted light reflected from objects in the scene, and may also include ambient light arriving from other sources).

The projecting unit may include a first light source and a second light source. Each light source may be controlled independently, or non-independently by a controlled configured to drive the light source to emit light. In one non-limiting example, the light projected by light source 112 may be at a wavelength between about 800 nm and 950 nm, have an average power between about 50 mW and about 500 mW, have a peak power between about 50 W and about 200 W, and a pulse width of between about 2 ns and about 100 ns. In addition, light source 112 may optionally be associated with an optical assembly used for manipulation of the light emitted by laser diode 202A (e.g., for collimation, focusing, etc.). It is noted that other types of light sources 112 may be used, and that the disclosure is not restricted to laser diodes. In addition, light source 112 may emit its light in different formats, such as light pulses, frequency modulated, continuous wave (CW), quasi-CW, or any other form corresponding to the particular light source employed. The projection format and other parameters may be changed by the light source from time to time based on different factors, such as instructions from processing unit 108.

The projected light of the first light source may be projected towards an outbound deflector that functions as a steering element for directing the projected light in the first field of view. In this example, scanning unit 104 may also include a pivotable return deflector 114B that direct photons (reflected light 206) reflected back from an object 208 within field of view 120 toward sensor 116. The reflected light is detected by sensor 116 and information about the object (e.g., the distance to object 212) is determined by processing unit 108. While FIG. 2 represents scanning along horizontal scan lines in alternating directions, in the case of the scanning system of FIG. 1, the scanning of all horizontal scan lines will generally proceed in a common direction (e.g., as dictated by the rotational direction of deflector 114 about scan axis 119).

According to some embodiments, scanning the environment around LIDAR system 100 may include illuminating field of view 120 with light pulses. The light pulses may have parameters such as: pulse duration, pulse angular dispersion, wavelength, instantaneous power, photon density at different distances from light source 112, average power, pulse power intensity, pulse width, pulse repetition rate, pulse sequence, pulse duty cycle, wavelength, phase, polarization, and more. Scanning the environment around LIDAR system 100 may also include detecting and characterizing various aspects of the reflected light. Characteristics of the reflected light may include, for example: time-of-flight (i.e., time from emission until detection), instantaneous power (e.g., power signature), average power across entire return pulse, and photon distribution/signal over return pulse period. By comparing characteristics of a light pulse with characteristics of corresponding reflections, a distance and possibly a physical characteristic, such as reflected intensity of object 212 may be estimated. By repeating this process across multiple adjacent portions 122, in a predefined pattern (e.g., raster, Lissajous or other patterns) an entire scan of field of view 120 may be achieved. In some situations, LIDAR system 100 may direct light to only some of the portions 122 in field of view 120 at every scanning cycle. These portions may be adjacent to each other, but not necessarily so.

In some embodiments, the light source may include a single, monolithic laser array including a plurality of laser emitters. By way of example, light source 112 may include a plurality of laser emitters fabricated on a single silicon wafer. Thus, laser emission unit may be in the form of a monolithic laser array. The term monolithic laser array refers to an array of laser light sources fabricated on a single (e.g., monolithic) silicon wafer. Because the laser light sources are fabricated on a single silicon wafer, the laser light sources on the monolithic laser array may be well aligned with each other. For example, one or more of laser emitters in laser array may include edge emitter lasers. It is contemplated, however, that one or more of laser emitters etc., may include other types of laser emitters (e.g., vertical-cavity surface-emitting laser (VCSEL)). In some embodiments, each of the plurality of laser beams may be a pulsed laser beam with a wavelength between 860 nm and 950 nm.

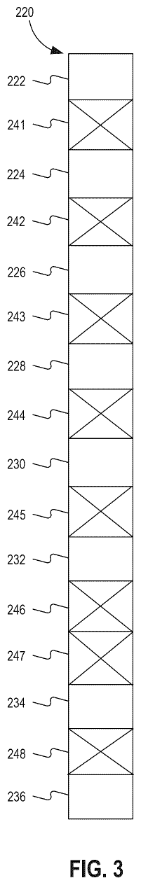

FIG. 3 illustrates an example of a monolithic laser array 220 including a plurality of laser emitters (e.g., 222, 224, 226, etc.). For example, one or more of laser emitters 222, 224, 226, etc., may be a pulsed laser emitter configured to emit a pulsed laser having a wavelength of between 860 nm-950 nm. It is also contemplated that in some embodiments, the one or more laser emitters 222, 224, 226, etc., may be configured to emit laser light having a wavelength of between 1300 nm-1600 nm.

In some embodiments, the monolithic laser array may include 4 active laser channels. In some embodiments, the monolithic laser array may include 8 active laser channels. In some embodiments, the monolithic laser array may include 16 active laser channels. In some embodiments, the monolithic laser array may include 32 active laser channels. In some embodiments, the monolithic laser array may include 64 active laser channels. For example, a laser array may include 16 laser sources arranged in a 1-D array, each laser source having a wavelength of about 905 nm. The light emitted from the laser sources may travel through various optical components associated with the optical path, including, e.g., lenses, collimators, etc.

### The Sensing Unit

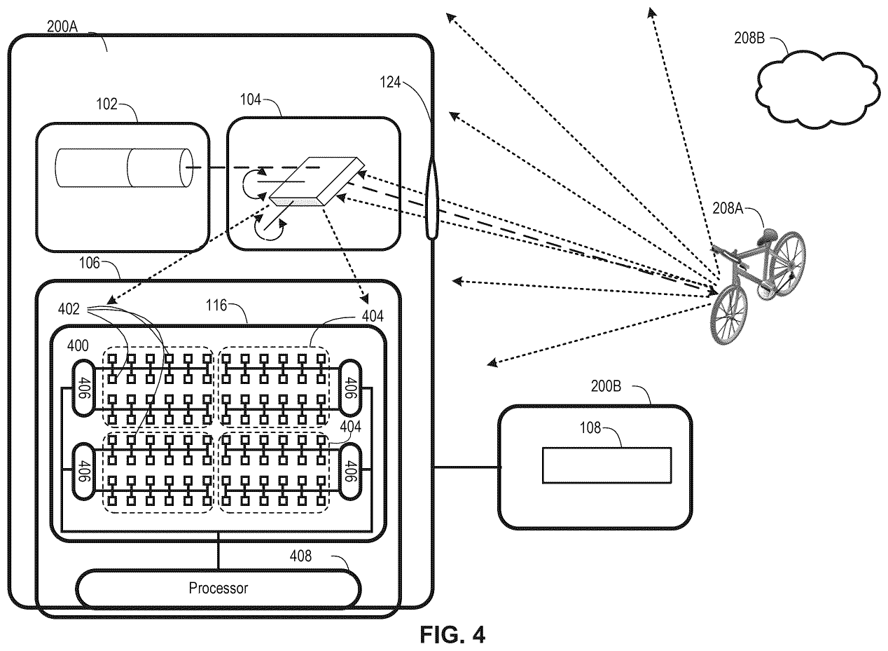

FIG. 4 illustrates an example of sensing unit 106. Sensor 116 may be composed of a matrix (e.g., 4×6) of pixels 404. In one embodiment, a pixel size may be about 1×1 mm. Sensor 116 may be two-dimensional in the sense that it has more than one set (e.g., row, column) of pixels 404 in two non-parallel axes (e.g., orthogonal axes, as exemplified in the illustrated examples). The number of pixels 404 in sensor 116 may vary between differing implementations, e.g., depending on the desired resolution, signal to noise ratio (SNR), desired detection distance, and so on. For example, sensor 116 may have anywhere between 5 and 5,000 pixels. In another example (not shown in the figure), sensor 116 may be a one-dimensional matrix (e.g., 1×4, 1×8, etc. pixels).

It is noted that each detector pixel 404 may include a plurality of detection elements 402, such as Avalanche Photo Diodes (APD), Single Photon Avalanche Diodes (SPADs), combination of Avalanche Photo Diodes (APD) and Single Photon Avalanche Diodes (SPADs) or detecting elements that measure both the time of flight from a laser pulse transmission event to the reception event and the intensity of the received photons. For example, each pixel may include anywhere between 20 and 5,000 SPADs. The outputs of detection elements 402 in each detector pixel 404 may be summed, averaged, or otherwise combined to provide a unified pixel output.

According to some embodiments, measurements from each detector pixel 404 may enable determination of the time of flight from a light pulse emission event to the reception event and the intensity of the received photons. The reception event may be the result of the light pulse being reflected from object 208. The time of flight may be a timestamp value that represents the distance of the reflecting object to optional optical window 124. Time of flight values may be realized by photon detection and counting methods, such as Time Correlated Single Photon Counters (TCSPC), analog methods for photon detection such as signal integration and qualification (via analog to digital converters or plain comparators) or otherwise.

In some embodiments, during a scanning cycle, each instantaneous position of at least one light deflector 114 may be associated with a particular portion 122 of field of view 120. The design of sensor 116 enables an association between the reflected light from a single portion of field of view 120 and multiple detector pixels 404. Therefore, the scanning resolution of LIDAR system may be represented by the number of instantaneous positions (per scanning cycle) times the number of pixels 404 in sensor 116. The information from each pixel 404 represents the basic data element from which the captured field of view in the three-dimensional space is built. This may include, for example, the basic element of a point cloud representation, with a spatial position and time of flight/range value. In one embodiment, the reflections from a single portion of field of view 120 that are detected by multiple pixels 404 may be returning from different objects located in the single portion of field of view 120. For example, the single portion of field of view 120 may be greater than 50×50 cm at the far field, which can include two, three, or more objects partly covered by each other.

Based on information about reflections associated with the initial light emission, processing unit 108 may be configured to determine the type of subsequent light emission to be projected towards portion 122 of field of view 120. The determined subsequent light emission for the particular portion of field of view 120 may be made during the same scanning cycle (i.e., in the same frame) or in a subsequent scanning cycle (i.e., in a subsequent frame).

### Rotatable LIDAR System

In some embodiments, a rotatable LIDAR system includes a rotor and a stator opposing the rotor. The term “rotor” broadly refers to a moving element of a rotatable LIDAR system. The rotor may be configured to rotate, for example, when the presence of certain electromagnetic fields generate a torque about an axis of the rotor. Similarly, the term “stator” broadly refers to a substantially stationary element of the rotatable LIDAR system. The stator may generate the electromagnetic fields resulting in the torque that causes the rotor to rotate. Examples of horizontal cross-sections of the rotor and the stator include round, square, triangular, rectangular, oval, or any other shaped cross-section. Consistent with the present disclosure, the rotor may include one or more components of LIDAR system 100. In some configurations, the rotor may include at least one light source (e.g., light source 112), a movable light deflector, (e.g., deflector 114), and a light detector (e.g., sensor 116); and the stator may include at least one processor (e.g., processor 118) and a motor configured to rotate the rotor. In other configurations, the rotor may include only some of the components listed above and the rest of the components may be included in the stator or vice-versa. In addition, each of the rotor and the stator may include a communications component (e.g., a communications winding) to facilitate communication with various components of the rotatable LIDAR system mounted on either the rotor or the stator.

In some embodiments, a rotor may include supporting components, such as a frame including stages on which system components may be mounted. A rotor may include a single stage, or multiple stages. Multiple stages may be stacked, for example, and displaced by a distance along a rotation axis about which the rotor rotates. The volume between the stages may house optical components mounted on a first stage (or lower stage). Additional components may be mounted on a second stage. The rotor may be housed in an exterior housing, including a window.

In some embodiments, a rotatable LIDAR system includes a motor configured to rotate the rotor. The term “motor” generally refers to any device that causes rotation. Such structures may be in the form of a device, engine, and/or mechanism that converts one form of energy into mechanical energy. Examples of motors may include, without limitation, electric motors, Direct Current (DC) motors, alternating current (AC) motors, vibration motors (without shaft weights), brushless motors, switched reluctance motors, synchronous motors, rotary motors, servo motors, coreless motors, stepper motors, universal motors, variations of one or more of the same, combinations of one or more of the same, or any other suitable motors. In some embodiments, the motor may be configured to rotate the rotor at speeds of greater than 3000rpm, greater than 4000 rpm, greater than 5000 rpm, greater than 6000 rpm, greater than 7000rpm, greater than 8000 rpm, greater than 9000 rpm, greater than 10,000 rpm, or at any other higher or lower rotational speed.

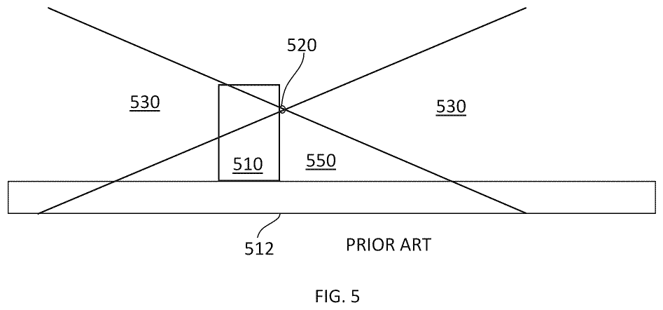

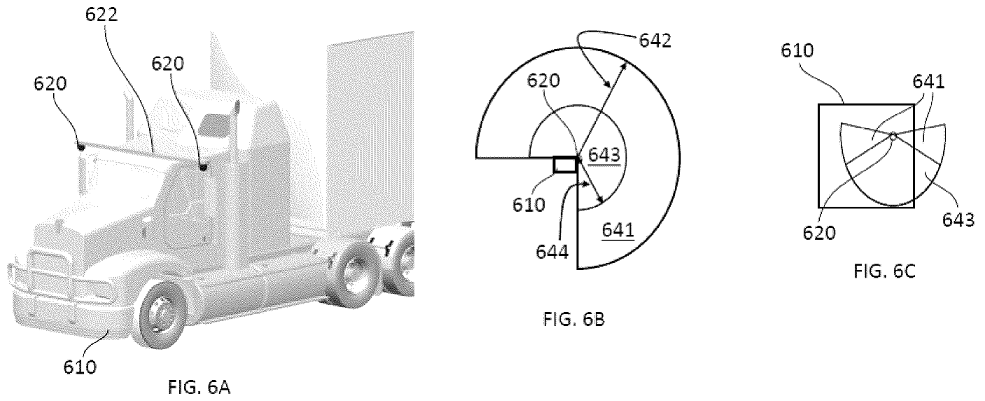

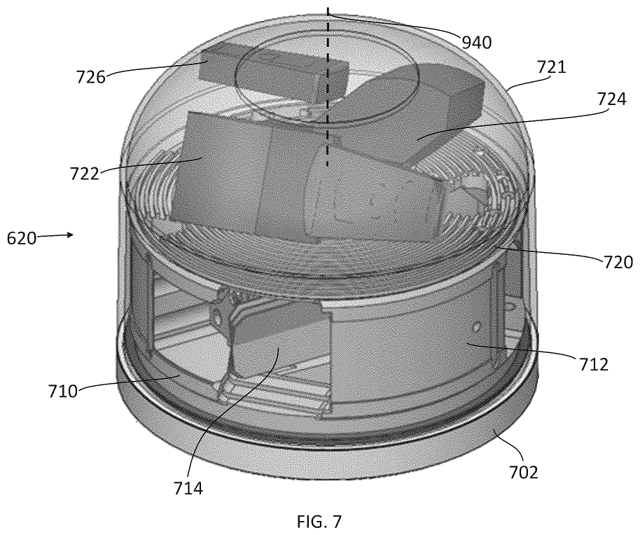

The rotatable LIDAR system further comprises multiple optical components mounted to the rotor such that the optical components are configured to rotate about central rotational axis 940 (FIG. 7) of the rotor as the rotor rotates about the central rotational axis. Typically, the optical components include a first light source and at least one second light source configured to emit light towards first and second portions of the FOV (described below with reference to FIGS. 6B-C), respectively, a first light detector configured to receive reflections of the light emitted by the first light source from objects in the first portion of the FOV, and a second light detector configured to receive reflections of the light emitted by the second light source from objects in the second portion of the FOV. As discussed above, the term “light source” broadly refers to any device configured to emit light. In one embodiment, the light source may be a laser such as a solid-state laser, laser diode, a high-power laser, or an alternative light source such as, a light emitting diode (LED)-based light source. From a geometric standpoint, a light beam may be described as a concentrated and coherent flow of photons, which represents the propagation of electromagnetic radiation traveling in a specific direction or along a designated path. Light beams may also be conceptualized as a grouping of light rays that travel together in a coherent manner. While the individual rays within the beam may exhibit slight variations in direction or wavelength, they generally share an overarching trajectory or orientation. The collective effect of these multiple rays forms the light beam, which possesses a discernible spatial distribution and may carry energy and information.

FIG. 5 schematically illustrates portions of the field of view scanned by an exemplary conventional LIDAR system 520 mounted to a vehicle 510 traveling over a ground surface 512. As illustrated in the figure, due to the arrangement of the optical components in LIDAR system 520, a portion 530 of the FOV corresponds to the portion of the FOV that can be imaged by LIDAR system 520, which leaves a portion 550 adjacent to vehicle 510 unimaged. Portion 550 thus represents a blind spot for LIDAR system 520. Although external mirrors may be used to reflect portions of blind spot 550 towards LIDAR system 520, such mirror systems are not desirable for two reasons. First, such external mirror systems may accumulate dirt and debris that may interfere with operation of LIDAR system 520. And second, such mirror systems are typically large, making the overall footprint of LIDAR system 520 very large.

FIG. 6A illustrates vehicle 610 equipped with LIDAR system 620 consistent with the present disclosure. As illustrated in FIG. 6A, LIDAR system 620 may be mounted to vehicle 610 via mounting structure 622. Although two LIDAR systems 620 have been illustrated in FIG. 6A as being mounted to vehicle 610, any number of LIDAR systems 620 may be mounted to vehicle 610. The location of the mounting structure 622 is also non-limiting and LIDAR systems may be mounted anywhere on vehicle 610.

FIG. 6B illustrates a top view of vehicle 610 with LIDAR system 620, and FIG. 6C illustrates a side view of vehicle 610 with LIDAR system 620. As illustrated in FIGS. 6B-C, the disclosed LIDAR system 620 is capable of scanning (i.e., emitting light into and receiving reflections from) a first portion 641 of the field of view with a first range 642, and also scanning a second portion 643 of the field of view with a second range 644. Typically, second range 644 is shorter than first range 642; for example, in some embodiments, the first range is at least double the second range.

Typically, the two portions of the field of view are offset from one another (i.e., neither one of the portions is completely subsumed in the other portion); for example, in some embodiments, the two portions do not overlap. Typically, the first portion of the field of view is similar to portion 530 (FIG. 5), in that it includes areas in front of, behind, and/or to the side of vehicle 610, while the second portion of the field of view includes blind spot 550 (FIG. 5) in the immediate vicinity of the vehicle. Thus, the disclosed LIDAR system 620 eliminates the blind spot 550 (see FIG. 5) that is prevalent with conventional LIDAR systems 520.

In some embodiments, the resolution of FOV measurement is lower for the second portion of the FOV than for the first portion of the FOV, given that, typically, objects of interest in the first portion of the FOV are likely to be more distant from the LIDAR system and, due to divergence of the illumination beams and the angular beam resolution, the beams illuminate a larger area. For example, at 1 meter an angular separation of 0.1° covers 1.75 mm, and at 100 meters, the same 0.1° separation covers 17.5 cm. Thus it is advantageous to measure a higher resolution in the first portion of the FOV to enable a higher level of detail to be detected at larger distances.

FIG. 7 illustrates an exemplary embodiment of LIDAR system 620. As illustrated in FIG. 7, LIDAR system 620 may include base 702, a portion of which functions as a stator, and rotary platform (or “rotor”) 712. In some embodiments, rotor 712 comprises at least two stages, which are typically spaced apart along central rotational axis 940 of the rotor. Optical components, including first and second light sources configured to emit light into the first and second portions of the FOV, respectively, and first and second light detectors configured to receive reflections of the light from objects in the first and second portions of the FOV, respectively, are mounted to the stages. For example, in some embodiments, rotor 712 comprises a first stage 710, to which the first light source and/or detector are mounted, and a second stage 720, to which the second light source and/or detector are mounted.

Typically, rotor 712 is configured to mount to a vehicle (e.g., via base 702) such that, when the vehicle is on a road, second portion 643 of the FOV, shown in FIGS. 6B-C, includes the road. For example, base 702 may be configured to allow attachment of LIDAR system 620 to, for example, mounting structure 622. Rotary platform 712 may be mounted to base 702 and may be rotatable by a motor about a longitudinal axis disposed generally perpendicular to base 702. First stage 710 may include deflector 714 mounted on rotary platform 712. Deflector 714 may allow for performing long range vertical scans to cover the portion 530 of the FOV. First stage 710 may also include one or more light sources (e.g., 112) and detectors similar to those discussed above. Second stage 720 may be spaced apart from first stage 710 along the longitudinal axis 940 of rotary platform 712. Second stage 720 may include a separate set of light sources 722, light detectors 726, and one or more optical components 724 configured to direct the light from light sources 722 towards the FOV and to direct reflected light received from the FOV towards detectors 726. However, unlike deflector 714, optical components 724 may not be able to move to scan the FOV. Instead, as described above, the light sources may employ VCSEL emitters that may allow second stage 720 to scan a relatively large angular span of portion 550 of the FOV. In some exemplary embodiments, light sources 722 may use vertical-cavity surface-emitting laser (VCSEL) arrays and detectors 726 may use silicon photomultiplier (SiPM) detectors. As also illustrated in FIG. 7, second stage 720 may be removably attachable to first stage 710 allowing users the flexibility to have LIDAR system 620 with only first stage 710 or with both first and second stages 710 and 720. First stage 710 may be configured to scan FOV portion 530 over a vertical angular span of about 15 to 20 degrees whereas second stage 720 may be configured to scan FOV portion 550 over an angular span of about 70 to 90 degrees.

In one exemplary embodiment, the wavelength of light emitted by the first light source differs from the wavelength of light emitted by the second light source. For example, in some embodiments, the wavelength of light emitted by light sources 112 in first stage 710 may be about 905 nm whereas the wavelength of the light emitted by the second light source 722 may be about 940 nm. An advantage of about 940 nm is that a VCSEL array, which typically emits at about 940 nm and at lower power (which is better for eye safety), can be used for the shorter-range illumination, for which lower power is sufficient. An advantage of about 905 nm is that edge emitter lasers, which typically emit at about 905 nm and at higher power, can be used for the longer-range illumination. More generally, an advantage of the different wavelengths is that the detector for each stage may be tuned and/or otherwise configured to be sensitive to the wavelength emitted by the corresponding light source, thus insulating the detectors from crosstalk. For example, assuming the wavelengths are 905 nm and 940 nm, the detector mounted to the second stage may be tuned to 940 nm, such that this detector is less sensitive (or not sensitive at all) to 905 nm, and thus avoids interference from the first light source.

In some exemplary embodiments, first and second stages 710 and 720 may be connected via a common sidewall or housing. Alternatively or additionally, in some exemplary embodiments, a rounded window 721, which may have a generally hemispherical shape, encloses second stage 720.

Typically, processor 118 (FIG. 1) is configured to control the first light source and second light source independently from one another. Alternatively or additionally, the processor is configured to receive signals from the first light detector, which are indicative of the reflections of the light emitted by the first light source, and signals from the second light detector, which are indicative of the reflections of the light emitted by the second light source. Based on the signals, the processor generates a combined point cloud including the objects from which the light emitted by the first light source was reflected and the objects from which the light emitted by the second light source was reflected.

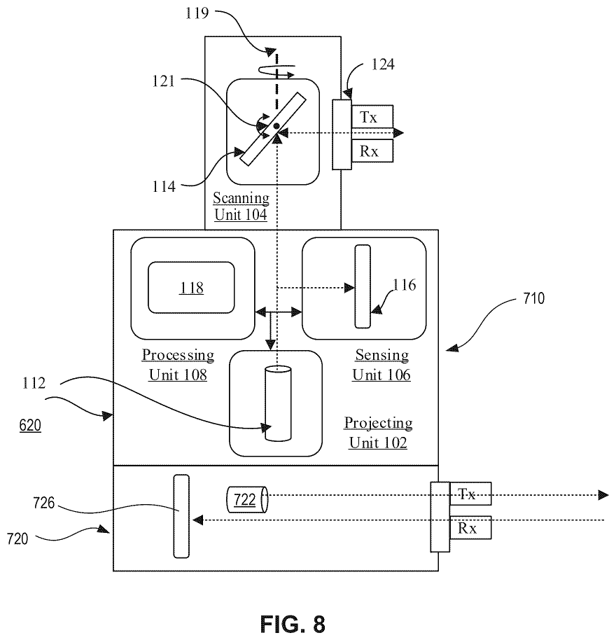

FIG. 8 illustrates a schematic view of LIDAR system 620. As illustrated in FIG. 8, first stage 710 of LIDAR system 620 is similar to LIDAR system 100 illustrated in FIG. 1 and described above. LIDAR system 620 additionally includes second stage 720 that may include light source 722 and detector 726 as illustrated in FIG. 8.

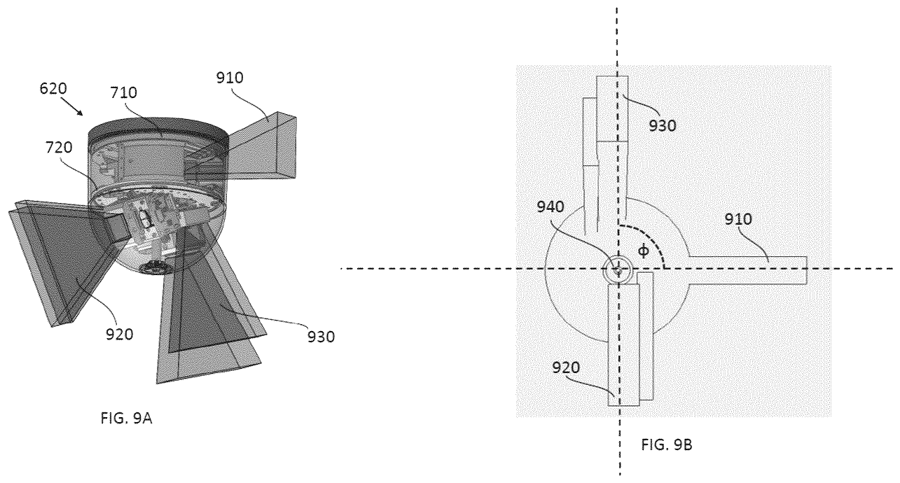

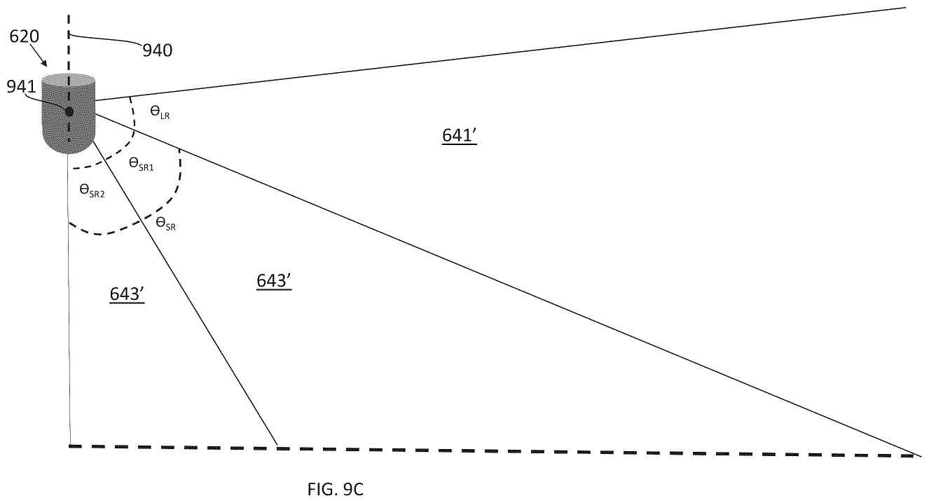

FIG. 9A illustrates a side view of LIDAR system 620 with light beams 910, 920, and 930. As illustrated in FIG. 9, light beam 910 is emitted by light source 112 in first stage 710. In contrast, light beams 920 and 930 are emitted by light source 722 in second stage 720. FIG. 9B illustrates a top view of LIDAR system 620 with light beams 910, 920, and 930. As illustrated in FIGS. 9A and 9B, light beams 910, 920, and 930 do not overlap. By positioning the light beams as shown in FIG. 9B, LIDAR system 620 may help ensure that the FOV portions scanned by light beams 910, 920, and 930 may not overlap. Further, positioning the light beams as shown in FIG. 9B may also help to eliminate any interference between light beams 910, 920, and 930. More generally, for any embodiment with two light sources for scanning different respective portions of the FOV, the instantaneous FOV illuminated by the first light source and the instantaneous FOV illuminated by the second light source have different yaw angles at the same time, the yaw angle being defined by rotation about central rotational axis 940. For example, in FIG. 9B, the yaw offset ϕ between the instantaneous FOVs is 90 degrees. In some embodiments, the instantaneous FOVs do not overlap at any time. Advantageously, the yaw offset reduces crosstalk, i.e., interference between light beams 910, 920, 930 transmitted towards the FOV, and their corresponding detectors. In other words, a detector 726 corresponding to a light source will face a different portion of the FOV than the light beams emitted by the other light sources, such that interference from those other light sources will be reduced (e.g., prevented).

Light beams 910, 920, and 930 may also be emitted in an asynchronous manner so that more than one set of light beams 910, 920, or 930 may not be directed towards the FOV at a particular instant of time. In some exemplary embodiments, a range of the FOV traversed by light beams 910 may be larger than a range of the FOV traversed by light beams 920 and 930. For example, the range of the FOV traversed by light beams 910 may be two or three times larger than a range of the FOV traversed by light beams 920 and 930.

Reference is now made to FIG. 9C, which is a schematic illustration of LIDAR system 620 illuminating a field of view, in accordance with some embodiments of the present disclosure.

Typically, the instantaneous FOV 641′ (and hence, first portion 641 of the FOV) illuminated by the first light source and the instantaneous FOV 643′ (and hence, second portion 643 of the FOV) illuminated by the at least one second light source have different pitch angles, the pitch angle being defined by a rotation about an axis 941 perpendicular to central rotational axis 940. At least because of the different pitch angles, typically, when the LIDAR system is mounted to a vehicle on a road, the first light source emits with a longer range “LR,” whereas the second light source emits with a shorter range “SR” that ends at the road, such that the second light source illuminates the road.

In some embodiments, the pitch range OSR of the second portion of the FOV is at least double the pitch range OLR of the first portion of the FOV. For example, for embodiments with two second light sources as in FIG. 9C, θ_{SR1}+θ_{SR2}>=2*Θ_{LR}, where θ_{SR1} and θ_{SR2} are the respective pitch ranges of the second light sources.

For example, as described above with reference to FIG. 7, in some embodiments, θ_{LR} is 15-20 degrees, and OSR is 70-90 degrees.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer-readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A rotatable LIDAR system, comprising:
a rotor configured to rotate about a central rotational axis; and
multiple optical components mounted to the rotor such that the optical components are configured to rotate about the central rotational axis, the optical components comprising:
a first light source configured to emit first light towards a first portion of a field of view (FOV) with a first range;
a first light detector configured to receive reflections of the first light from first objects in the first portion of the FOV;
at least one second light source configured to emit second light towards a second portion of the FOV with a second range shorter than the first range; and
a second light detector configured to receive reflections of the second light from second objects in the second portion of the FOV.

2. The rotatable LIDAR system according to claim 1, wherein the rotor comprises at least two stages, and wherein the optical components are mounted to the stages.

3. The rotatable LIDAR system according to claim 2, wherein the at least two stages are spaced apart along the central rotational axis.

4. The rotatable LIDAR system according to claim 3, wherein the first light source is mounted to a first one of the at least two stages, and the second light source is mounted to a second one of the at least two stages.

5. The rotatable LIDAR system according to claim 4, further comprising a rounded window enclosing the second one of the at least two stages.

6. The rotatable LIDAR system according to claim 2, wherein the at least two stages are removably attached to one another.

7. The rotatable LIDAR system according to claim 1, wherein the first portion of the FOV is offset from the second portion of the FOV.

8. The rotatable LIDAR system according to claim 1, wherein the first portion of the FOV and the second portion of the FOV do not overlap.

9. The rotatable LIDAR system according to claim 1, wherein a yaw angle is defined by rotation about the central rotational axis, and wherein an instantaneous FOV illuminated by the first light source and an instantaneous FOV illuminated by the second light source have different yaw angles at any time.

10. The rotatable LIDAR system according to claim 9, wherein an instantaneous FOV illuminated by the first light source and an instantaneous FOV illuminated by the second light source do not overlap at any time.

11. The rotatable LIDAR system according to claim 1, wherein a pitch angle is defined by a rotation about an axis perpendicular to the central rotational axis, and wherein an instantaneous FOV illuminated by the first light source and an instantaneous FOV illuminated by the second light source have different pitch angles.

12. The rotatable LIDAR system according to claim 11, wherein a pitch range of the second portion of the FOV is at least double a pitch range of the first portion of the FOV.

13. The rotatable LIDAR system according to claim 1, wherein the rotor is configured to mount to a vehicle such that, when the vehicle is on a road, the second portion of the FOV includes the road.

14. The rotatable LIDAR system according to claim 1, wherein the first light source comprises an edge emitter laser.

15. The rotatable LIDAR system according to claim 1, wherein the second light source comprises a VCSEL array.

16. The rotatable LIDAR system according to claim 1, wherein a wavelength of the first light differs from a wavelength of the second light.

17. The rotatable LIDAR system according to claim 1, wherein a resolution of FOV measurement is lower for the second portion of the FOV than for the first portion of the FOV.

18. The rotatable LIDAR system according to claim 1, wherein the first range is at least double the second range.

19. The rotatable LIDAR system according to claim 1, further comprising a processor configured to control the first light source and second light source independently from one another.

20. The rotatable LIDAR system according to claim 1, further comprising a processor configured to:
receive signals from the first light detector and second light detector indicative of the reflections of the first light and the reflections of the second light, and
based on the signals, generate a combined point cloud including the first objects and the second objects.

21. The rotatable LIDAR system according to claim 1. wherein the optical components further comprise a scanning unit configured to deflect the first light towards the first portion of the FOV.
